(19) United States
(12) Patent Application Publication
(10) Pub. No.: US 2025/0296652 A1
(43) Pub. Date: Sep. 25, 2025

(54) SADDLE RIDING VEHICLE

(71) Applicant: HONDA MOTOR CO., LTD., Tokyo (JP)

(72) Inventors: Eiji Sugiyama, Tokyo (JP); Yasumasa Yamamoto, Tokyo (JP); Makoto Matsumura, Tokyo (JP); Shogo Matsumoto, Tokyo (JP)

(21) Appl. No.: 19/079,503

(22) Filed: Mar. 14, 2025

(30) Foreign Application Priority Data
Mar. 22, 2024 (JP) 2024-046951

(51) Int. Cl. B62J 50/22; B62J 17/02; B62J 43/28

(52) U.S. Cl. CPC B62J 50/22; B62J 17/02; B62J 43/28

(57) ABSTRACT

A saddle riding vehicle includes a meter device configured to display vehicle information, a right cowl disposed in front of the meter device and overlapping with the meter device when seen in a front view of the vehicle, and a USB charger having a connection port that is able to be connected to external equipment, the USB charger is disposed between a rear end of the meter device and a front end of the right cowl in a vehicle forward/rearward direction and is disposed outside of an outer side of the meter device in a vehicle width direction, the meter device and the right cowl are fixed to a vehicle body via the same support frame, and the USB charger is fixed to the support frame.

### CROSS-REFERENCE TO RELATED APPLICATION

Priority is claimed on Japanese Patent Application No. 2024-046951, filed Mar. 22, 2024, the content of which is incorporated herein by reference.

### BACKGROUND OF THE INVENTION

### Field of the Invention

The present invention relates to a saddle riding vehicle.

### Description of Related Art

In the related art, as a charging structure of a saddle riding vehicle such as a motorcycle or the like, a configuration including a power supply device that can charge external electrical equipment around a meter device disposed in front of a boarding position is known (for example, see Japanese Unexamined Patent Application, First Publication No. 2022-184502, Chinese Utility Model No. 202508228).

In Japanese Unexamined Patent Application, First Publication No. 2022-184502, a power supply device is disposed at a position that does not overlap with a meter device in a vehicle width direction and behind and below the meter device. In Chinese Utility Model No. 202508228, a connection port of the external equipment in the power supply device is disposed to the side of the meter device.

### SUMMARY OF THE INVENTION

Incidentally, in recent years, meter devices have tended to become larger due to their increased functionality, and there is a need for a more efficient and compact structure for providing a power supply device.

An aspect of the present invention is directed to providing a saddle riding vehicle capable of installing a power supply device efficiently and compactly around a meter device.

A first aspect of the present invention is a saddle riding vehicle (1) including: a display device (40) configured to display vehicle information; a vehicle body cover (45, 145) that is disposed in front of the display device (40) and that is overlapping with the display device (40) when seen in a front view of the vehicle; and a power supply device (50) having a connection port (51a) that is able to be connected to external equipment, the power supply device (50) being disposed between a rear end (P1) of the display device (40) and a front end (P2, P2′) of the vehicle body cover (45, 145) in a vehicle forward/rearward direction and is disposed outside than an outer side (41e) of the display device (40) in a vehicle width direction, the display device (40) and the vehicle body cover (45, 145) being fixed to a vehicle body via the same support frame (70, 170), and the power supply device (50) being fixed to the support frame (70, 170). According to this configuration, the power supply device is disposed between the display device and the vehicle body cover in the vehicle forward/rearward direction and outside the display device in the vehicle width direction, and is hidden by the vehicle body cover, thereby improving the appearance from the front of the vehicle and enabling the power supply device to be located at a position that is easily visible to the driver. In addition, since the power supply device can be fixed to the vehicle body without requiring a fixing bracket for the power supply device, the power supply device can be efficiently and compactly installed around the display device and the vehicle body cover without increasing the number of parts.

According to a second aspect of the present invention, in the first aspect, a part of the power supply device (50) at least partially overlaps the display device (40) when seen in a side view of the vehicle.

According to this configuration, by disposing the power supply device and the display device to overlap each other when seen in a side view, the power supply device can be arranged around the display device while keeping the areas around the power supply device and the display device compact in the vehicle forward/rearward direction and the upward/downward direction.

According to a third aspect of the present invention, in the first or second aspect, a connection port (51a) of the power supply device (50) is disposed inside than an outer side (47b, 147b) of the vehicle body cover (45, 145) in the vehicle width direction when seen in a plan view of the vehicle.

According to this configuration, by disposing the connection port of the power supply device inside than the vehicle body cover in the vehicle width direction, the vehicle body cover can prevent water or dust from getting into the connection port.

According to a fourth aspect of the present invention, in any one of the first to third aspects, when seen in a side view of the vehicle, at least a part of the power supply device (50) overlaps with the vehicle body cover (45, 145), and the connection port (51a) does not overlap with the vehicle body cover (45, 145).

According to this configuration, by overlapping the power supply device with the vehicle body cover when seen in a side view of the vehicle, the power supply device is made less noticeable and the appearance of the surrounding area is improved, and by not overlapping the connection port of the power supply device with the vehicle body cover when seen in a side view of the vehicle, the connection port is easier for the user to see and operability when inserting and removing the cable of the external equipment can be improved.

According to a fifth aspect of the present invention, in any one of the first to fourth aspects, a restricting part (47g, 64c) configured to restrict movement of the power supply device (50) in a direction of removing the power supply device (50) from the support frame (70, 170) is provided.

According to this configuration, by restricting the movement of the power supply device in a direction of removing the power supply device from the power supply device, it is possible to make the power supply device more difficult to remove from a vehicle and improve the anti-theft properties of the power supply device.

According to a sixth aspect of the present invention, in any one of the first to fifth aspects, an outer side (41e) of the display device (40) which is outside in the vehicle width direction is inclined to be located outward in the vehicle width direction as it goes to the rear of the vehicle when seen in a plan view of the vehicle, and the power supply device (50) located outside of the display device (40) in the vehicle width direction is inclined such that an insertion/removal direction (L1) of the external equipment with respect to the connection port (51a) is located outward in the vehicle width direction as it goes to the rear of the vehicle when seen in a plan view of the vehicle.

According to this configuration, by inclining both the outer side of the display device and the insertion/removal direction of the power supply device so as to be located further outward in the vehicle width direction as it goes to the rear of the vehicle, the power supply device is disposed along the outer side of the display device (parallel to the outer side), making it easier to insert and remove the cable of the external equipment into the power supply device.

According to a seventh aspect of the present invention, in the fifth aspect, the restricting part (47g) is provided on the vehicle body cover (45).

According to this configuration, by providing the restricting part on the vehicle body cover that restricts the removal of the power supply device, the anti-theft properties of the power supply device can be improved without increasing the number of parts.

According to an eighth aspect of the present invention, in any one of the first to seventh aspects, the power supply device (50) is located below an upper end (P3) of the display device (40) in a vehicle upward/downward direction when seen in a side view of the vehicle, and at least a part of the power supply device (50) is disposed at a side facing above and rear of the vehicle in a normal direction (V1) of a display surface (42) with reference to the display surface (42) of the display device (40).

According to this configuration, by disposing the power supply device below the upper end of the display device, the power supply device can be protected from disturbances from above without the need for additional parts, and by disposing the power supply device above and behind the display surface, the power supply device is closer to the occupant side, improving accessibility to the user.

According to a ninth aspect of the present invention, in the eighth aspect, at least a part of the connection port (51a) of the power supply device (50) is disposed on an upper rear side of the display surface (42) in the normal direction (V1) when seen in a side view of the vehicle.

According to this configuration, by disposing the connection port of the power supply device on the upper rear side of the display surface, the connection port protrudes toward the occupant side beyond the display surface, thereby improving the visibility of the connection port and accessibility of the user.

According to a tenth aspect of the present invention, in any one of the first to ninth aspects, the power supply device (50) is connected to a harness (64a) connected to an in-vehicle power supply, and the harness (64a) is routed along a rear surface of the vehicle body cover (45) in a vehicle width direction and then coupled to another harness in front of the display device (40).

According to this configuration, the harness connecting the power supply device and the power supply extends between the vehicle body cover and the display device in the vehicle width direction and is connected to another harness in front of the display device, making it possible to effectively utilize the limited space in the saddle riding vehicle and route the power supply harness.

According to an eleventh aspect of the present invention, in any one of the first to seventh aspects, the power supply device (50) is located below an upper end (P3) of the display device (40) in a vehicle upward/downward direction when seen in a side view of the vehicle, and at least a part of the power supply device (50) is disposed at a side in front of and below the vehicle in a normal direction (V1) of the display surface (42) with reference to a display surface (42) of the display device (40).

According to this configuration, by disposing the power supply device below the upper end of the display device, the power supply device can be protected from disturbances from above without the need for additional parts, and by disposing the power supply device below and in front of the display surface, the power supply device can be disposed compactly between the display device and the vehicle body cover.

According to a twelfth aspect of the present invention, in any one of the first to seventh and eleventh aspects, when seen in a side view of the vehicle, at least a part of the power supply device (50) overlaps with the display device (40), and the connection port (51a) is located below a lower end (41d) of the display device (40) in a vehicle upward/downward direction.

According to this configuration, by disposing the power supply device to overlap with the outside of the display device in the vehicle width direction when seen in a side view, and by disposing the connection port below the display device, the power supply device is disposed compactly and easily visible when seen in a side view of the vehicle, and further, it is easy for the user to recognize the presence of the power supply device by touching the lower portion of the display device.

According to a thirteenth aspect of the present invention, in the fifth aspect, the power supply device (50) is connected to a harness (64a) connected to an in-vehicle power supply, the support frame (170) is attached with a fixing part (64c) configured to fix the harness (64a), and the fixing part (64c) serves as the restricting part.

According to this configuration, the harness fixing part attached to the support frame also serves as the restricting part configured to restrict the removal of the power supply device, thereby improving the anti-theft properties of the power supply device without increasing the number of parts.

According to the aspect of the present invention, it is possible to provide a saddle riding vehicle enabling installing a power supply device efficiently and compactly around a meter device.

### BRIEF DESCRIPTION OF THE DRAWINGS

FIG. 1 is a left side view of a motorcycle (saddle riding vehicle) according to a first embodiment of the present invention.

FIG. 2 is a left side view of an area including a right cowl and a meter device of the motorcycle.

FIG. 3 is a plan view of the area including the right cowl and the meter device.

FIG. 4 is a rear view of the area including the right cowl and the meter device.

FIG. 5 is a plan view of a state in which the meter device is removed from FIG. 2.

FIG. 6 is a plan view of a charger assembly located on a left side of the meter device.

FIG. 7 is a perspective view of the charger assembly.

FIG. 8 is an exploded perspective view of the charger assembly.

FIG. 9 is a left side view of a motorcycle (saddle riding vehicle) according to a second embodiment of the present invention.

FIG. 10 is a left side view of an area including a right cowl and a meter device of the motorcycle of the second embodiment.

FIG. 11 is a plan view of the area including the right cowl and the meter device of the second embodiment.

FIG. 12 is a front view of the area including the right cowl and the meter device of the second embodiment.

FIG. 13 is a left side view of a charger assembly of the second embodiment.

FIG. 14 is a plan view of the charger assembly of the second embodiment.

### DETAILED DESCRIPTION OF THE INVENTION

Hereinafter, embodiments of the present invention will be described with reference to the accompanying drawings. Further, directions of forward, rearward, leftward, rightward, and the like, in the following description are the same directions in a vehicle described below unless the context indicates otherwise. In addition, in appropriate places in the drawings used in the following description, an arrow FR indicates the forward direction of the vehicle, an arrow LH indicates the leftward direction of the vehicle, an arrow UP indicates the upward direction of the vehicle, and line CL indicates a lateral center of a vehicle body. The term “intermediate” used in the following description means not only a center between both ends of an object but also an inner range between both the ends of the object. In the following description, a vehicle body of a saddle riding vehicle is stationary and upright, with no inclination to the left or right, with a steering angle of 0 degrees, and is in an empty car 1G state on a horizontal surface.

### First Embodiment

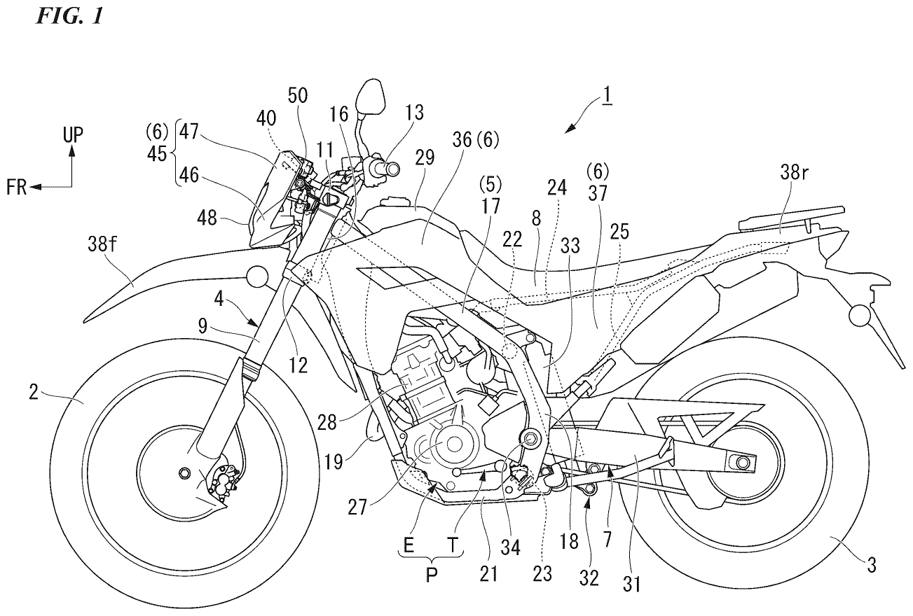

FIG. 1 is a left side view of a motorcycle (saddle riding vehicle) 1 of a first embodiment.

As shown in FIG. 1, the motorcycle 1 of the first embodiment is an off-road type saddle riding vehicle. The motorcycle 1 has a large up and down stroke amount for the wheels, a large ground clearance for the vehicle body, a compact and lightweight vehicle body, and a good mass concentration for the vehicle body.

The motorcycle 1 includes a front wheel 2, a rear wheel 3, a front wheel suspension system 4, a vehicle body frame 5, a vehicle body cover 6, a rear wheel suspension system 7, and a power unit P.

The front wheel suspension system 4 includes a pair of left and right front forks 9 configured to axially support the front wheel 2 at lower end portions thereof, a top bridge 11 and a bottom bridge 12 provided to bridge between upper portions of the pair of front forks 9, and a stem pipe (not shown) provided to bridge between the top bridge 11 and the bottom bridge 12 and inserted through a head pipe 16. The front wheel 2 is steerably supported on the head pipe 16 of the vehicle body frame 5 via the front wheel suspension system 4. A bar type steering handle 13 is supported on the top bridge 11. Hereinafter, the front wheel suspension system 4 may be referred to as a steering system 4.

The vehicle body frame 5 includes the head pipe 16, a pair of left and right main frames 17, a pair of left and right pivot frames 18, a single down frame 19, a pair of left and right lower frames 21, a cross member 22 configured to connect upper portions of the left and right pivot frames 18, and a lower cross member 23 configured to connect lower portions of the left and right pivot frames 18, which are integrally coupled to each other through welding or the like.

The vehicle body frame 5 further includes a pair of left and right seat rails 24 extending rearward from the upper portions of the left and right pivot frames 18, and a pair of left and right support rails 25 extending rearward and upward from vertical intermediate portions of the left and right pivot frames 18. Rear end portions of the left and right support rails 25 are coupled to rear portions of the seat rails 24 on the same left and right sides from below. The left and right seat rails 24 are appropriately connected by a cross frame. The left and right seat rails 24 and the left and right support rails 25 are integrally coupled through welding or the like, and constitute a seat frame that supports a seat 8 on which an occupant sits.

A pivot shaft 34 extending in a vehicle width direction bridges between vertical intermediate portions of the left and right pivot frames 18. An upper end portion of a rear cushion 33 is connected to the cross member 22 between the upper portions of the left and right pivot frames 18. A link mechanism 32 is connected to the lower cross member 23 between the lower portions of the left and right pivot frames 18. In the vehicle body frame 5, the power unit P that is a prime mover of the motorcycle 1 is mounted in an area surrounded by the main frames 17, the pivot frames 18, the down frame 19 and the lower frames 21 when seen in a side view.

The vehicle body cover 6 covers the vehicle body frame 5 and the like. The vehicle body cover 6 includes a pair of left and right front side cowls 36, a pair of left and right rear side cowls 37, and a right cowl 45 in front of the handle 13.

The left and right front side cowls 36 are disposed from a position below both left and right sides of a front portion of the seat 8 to a position overlapping an upper portion of the down frame 19 when seen in a side view in a vehicle width direction. The left and right front side cowls 36 extend flared forward from below the front portion of the seat 8 when seen in a side view. At least one of the left and right front side cowls 36 functions as an air guide plate (radiator shroud) to a radiator supported on a side portion of the down frame 19.

The left and right rear side cowls 37 are disposed at positions below both left and right sides of a rear portion of the seat 8 when seen in a side view. The side cowls are provided to cover the seat frame from outer sides in the vehicle width direction. A rear fender 38r extends rearward behind the seat 8. The rear fender 38r is disposed above the rear wheel 3 with an interval therebetween. Reference sign 38f in the drawings designates a front fender disposed above the front wheel 2 with an interval therebetween and supported on the bottom bridge 12. The right cowl 45 will be described below in detail.

The rear wheel suspension system 7 includes a swing arm 31 configured to axially support the rear wheel 3 on a rear end portion thereof, the link mechanism 32 configured to connect a front portion of the swing arm 31 and the lower cross member 23, and the rear cushion 33 that bridges between the link mechanism 32 and the cross member 22.

The swing arm 31 is disposed below a rear portion of the vehicle body and extends in the forward/rearward direction. The front end portion of the swing arm 31 is vertically swingably supported on the pair of pivot frames 18 via the pivot shaft 34.

The link mechanism 32 appropriately connects the front portion of the swing arm 31 and the lower end portions of the lower cross member 23 and the rear cushion 33, and changes a ratio of a stroke of the rear cushion 33 with respect to the stroke of the rear wheel 3.

The power unit P includes an engine (internal combustion engine) E that is a driving source, and a transmission T. The engine E is, for example, a single cylinder engine having a crankshaft parallel to the vehicle width direction (leftward/rightward direction). A lower portion of the engine E constitutes a crank case 27. A cylinder 28 is provided upright above the front portion of the crank case 27. The transmission T is accommodated in the rear portion of the crank case 27.

A fuel tank 29 is provided above the cylinder 28 and between the left and right main frames 17. The front portion of the seat 8 rests on the rear portion upper surface of the fuel tank 29.

### <Meter Device 40>

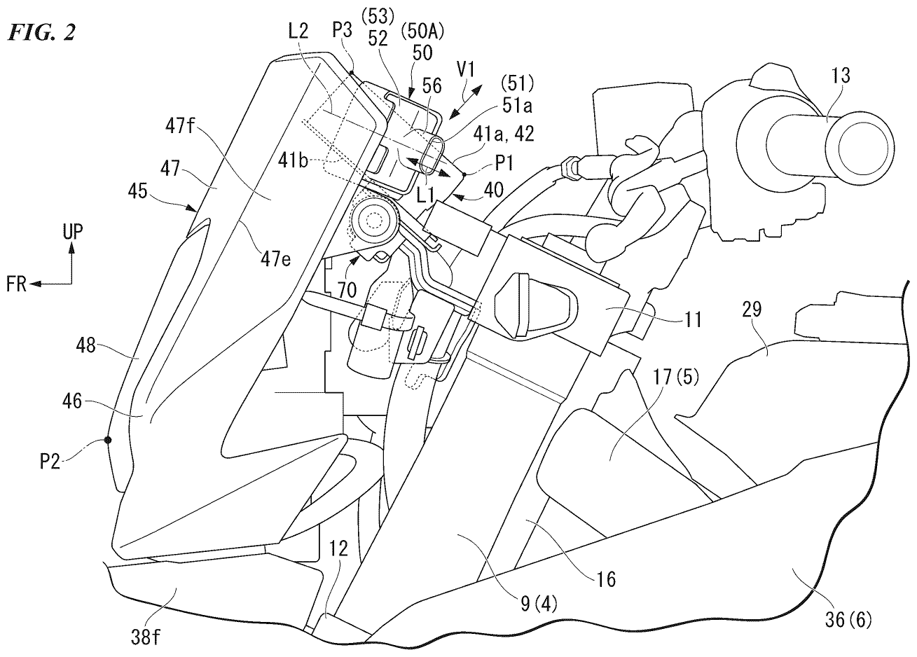

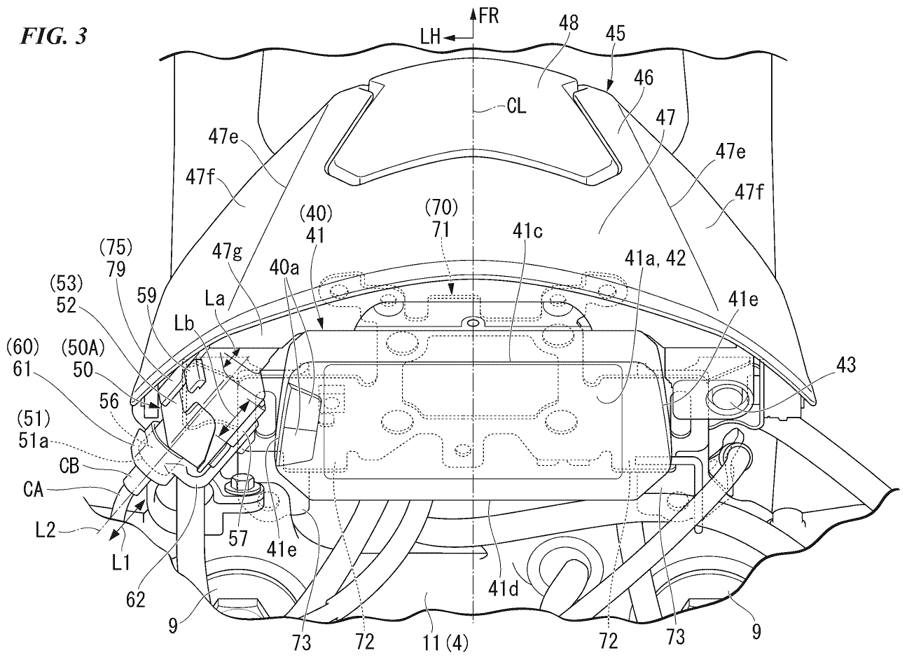

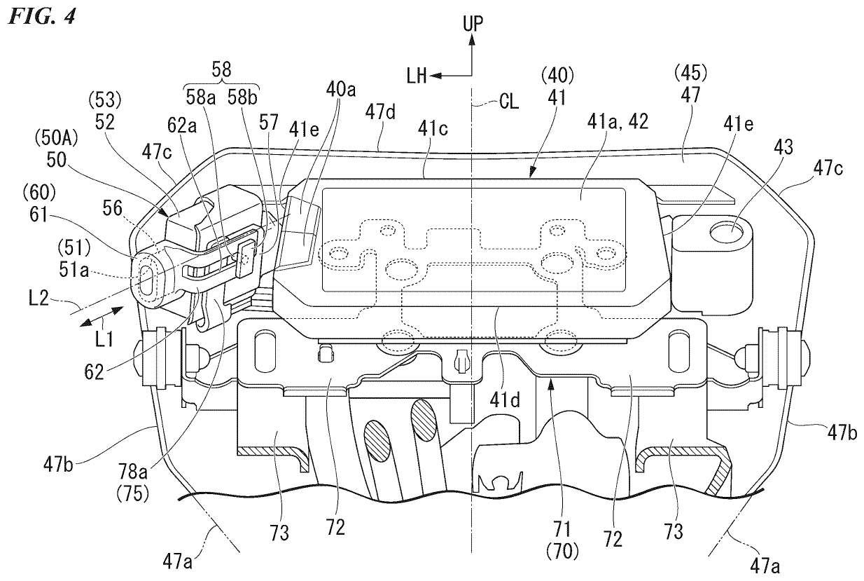

FIG. 2 is a left side view of an area including the right cowl 45 and a meter device 40 of the motorcycle 1. FIG. 3 is a plan view of the area including the right cowl and the meter device 40. FIG. 4 is a rear view of the area including the right cowl 45 and the meter device 40.

As shown in FIG. 2 to FIG. 4, the meter device 40 configured to display vehicle information such as a vehicle speed or the like to the occupant is provided in front of the top bridge 11.

The meter device 40 has a housing 41 that has a generally rectangular parallelepiped appearance that is long in the leftward/rightward direction. The meter device 40 has a rectangular display surface 42 that is slightly smaller than the housing 41 on a substantially rectangular side surface (hereinafter referred to as a rear inclined surface 41a) facing upward and toward the rear. The housing 41 has a thickness direction V1 that is a normal direction of the display surface 42 (shown by an arrow V1 in the drawings), and is flattened with a reduced width in the thickness direction V1.

The display surface 42 can display various pieces of vehicle information using, for example, a liquid crystal panel. An upper portion of the display surface 42 has a plurality of indicator lamps arranged side by side. An operation button 40a configured to operate the display on the display surface 42 is provided on the rear inclined surface 41a in a portion which is located left than the display surface 42. For example, a switch button 43 configured to operate an anti-lock brake system (ABS) or switch engine output characteristics is provided in a portion of the meter device 40 which is located right than the right outer side 41e.

Referring to FIG. 4, the meter device 40 has an upper side 41c and a lower side 41d in the leftward/rightward direction when seen in the normal direction V1, and the pair of left and right outer sides 41e located on an outer side in the leftward/rightward direction. The left and right outer sides 41e are inclined so that the lower sides are positioned further outward in the vehicle width direction. That is, the meter device 40 has a trapezoidal outer shape when seen in the normal direction V1. The meter device of the first embodiment has the rear inclined surface 41a with a standing angle of about 45 degrees relative to the horizontal surface.

### <Right Cowl 45>

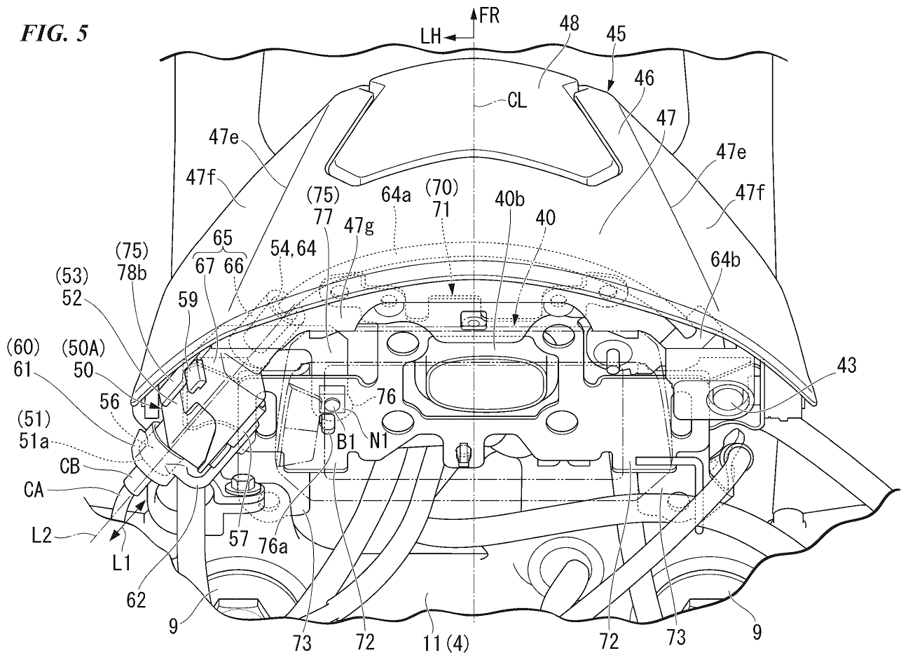

FIG. 5 is a plan view in a state in which the meter device 40 is removed from FIG. 2.

As shown in FIG. 2 to FIG. 5, the right cowl 45 configured to cover a range from surroundings of a headlight 48 to above is provided in front of the meter device 40.

The right cowl 45 integrally includes a right cover 46 configured to cover surroundings of the headlight 48 when seen in a front view, and a meter visor 47 extending above the right cover 46 and configured to cover the meter device 40 from the front. The right cowl 45 is attached to a support frame 70 supported on the steering system 4 of the vehicle body together with the headlight 48 and the meter device 40. The right cowl 45, the headlight 48 and the meter device 40 of the first embodiment is pivotable together with the steering system 4.

Referring to FIG. 4, the right cowl 45 is provided to overlap with the entire meter device 40 at a position in front of the meter device 40 when seen in a front view of the vehicle (when seen in a front view). The right cowl 45 includes a pair of left and right lower portion outer sides 47a extending obliquely outward and upward from the lower portion of the headlight 48 in the vehicle width direction, a pair of left and right outer sides 47b extending outward and upward in the vehicle width direction steeply more than the lower portion outer sides 47a from outer ends of the lower portion outer sides 47a in the vehicle width direction, a pair of left and right upper portion outer sides 47c obliquely extending inward and upward from upper ends of the left and right outer sides 47b in the vehicle width direction, and an upper side 47d extending substantially horizontally between upper ends of the left and right upper portion outer sides 47c when seen in a front view of the vehicle. In the description of the first embodiment, for convenience of illustration, a reference of the area including the right cowl 45 and the meter device 40 will be made.

In each of the left and right side portions of the right cowl 45, ridgelines 47e that are bent convexly toward the front of the vehicle when seen from above are formed between inner ends of the lower portion outer sides 47a in the vehicle width direction and upper ends of the upper portion outer sides 47c. The area of the right cowl 45 between the left and right ridgelines 47e is made as a curved portion that is convex toward the front of the vehicle when seen from above. The area of the right cowl 45 that is more outward in the vehicle width direction than the left and right ridgelines 47e is made as a cowl outer side portion 47f that is inclined so as to be positioned rearward as it goes outward in the vehicle width direction when seen from above.

### <USB Charger 50>

As shown in FIG. 2 to FIG. 5, a USB charger 50 having a connection port 51a that can be connected to external equipment is provided behind the right cowl 45 and on a left side of the meter device 40. The USB charger 50 integrally includes a transformer (DC-DC converter) 52 and a USB socket 51. The USB charger 50 can be connected to external electrical equipment such as a smart phone or the like by a USB (universal serial bus) connector. The USB charger 50 converts electric power of an in-vehicle battery from 12V to 5V, enabling it to supply the electric power to and charge the external equipment. The USB socket 51 of the USB charger 50 constitutes the USB connector together with a USB terminal CB provided on a tip portion of a power supply cable CA on the side of the external equipment.

The USB socket 51 of the embodiment includes at least a terminal for power supply and may not include a terminal for data communication. If a USB socket for communicating with the control device of motorcycle 1 is provided instead of the USB socket 51, the USB socket has the terminal for data communication and is connected to a data communication line on the vehicle body side. The USB socket 51 may be used not only for power supply but also as an equipment connecting part capable of electrically connecting external electrical equipment.

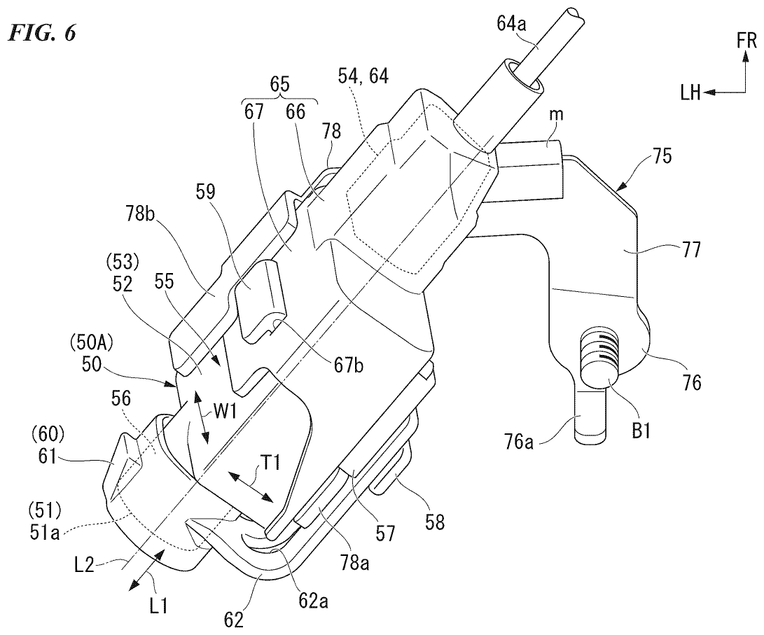

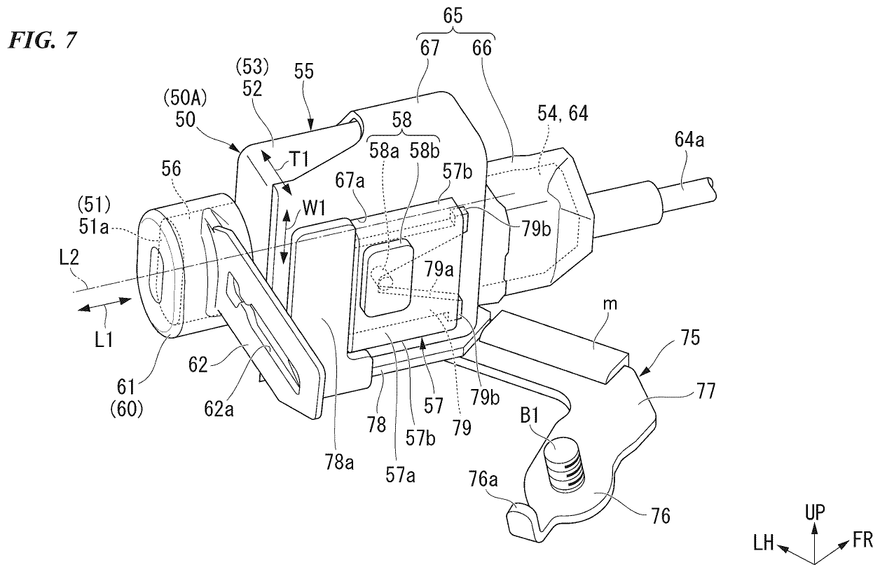

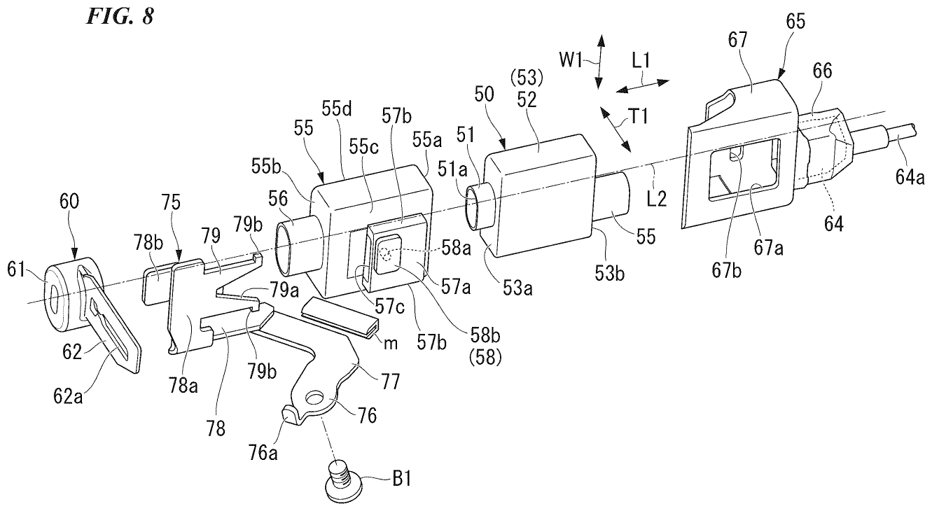

FIG. 6 is a plan view of a charger assembly 50A located on a left side of the meter device 40. FIG. 7 is a perspective view of the charger assembly 50A. FIG. 8 is an exploded perspective view of the charger assembly 50A.

Referring to FIG. 6 to FIG. 8, the USB charger 50 is formed by integrating a charger main body 53 including the transformer 52 with the USB socket 51, and, for example, by attaching a resin cover 55 to form the charger assembly 50A. The charger assembly 50A is attached to a tip side of a support stay 75. A base end side of the support stay 75 is attached to the support frame 70 that supports the meter device 40 and the right cowl 45 on the steering system 4.

The charger main body 53 has a flat rectangular parallelepiped appearance with a reduced width in a thickness direction (indicated by arrow T1 in the drawings). The USB socket 51 protrudes from a central portion of one side (hereinafter referred to as a first side 53a) of the charger main body 53 when seen in the thickness direction T1. At the tip of the USB socket 51, there is an opening for the connection port 51a to which the USB terminal CB for external equipment can be connected.

When the charger main body 53 is seen in the thickness direction T1, a coupler 54 protrudes from a second side 53b opposite the first side 53a. The coupler 54 is protrudingly provided at a position offset toward one end of the second side 53b. A connector 64 of a branch harness 64a that leads to the main harness on the side of the vehicle body can be connected to the coupler 54. The USB charger 50 can be connected to the in-vehicle power supply (battery) through the branch harness 64a, the main harness, and the like. Hereinafter, when the charger main body 53 is seen in the thickness direction T1, a direction perpendicular to the first side 53a and the second side 53b is referred to as a lengthwise direction L1, and a direction along the first side 53a and the second side 53b is referred to as a widthwise direction W1. The USB socket 51 protrudes from the first side 53a to one side in the lengthwise direction L1, and allows the USB terminal CB of the external equipment to be inserted and removed along the lengthwise direction L1. The lengthwise direction L1 is also an insertion/removal direction of the USB terminal CB. The coupler 54 protrudes from the second side 53b to the other side in the lengthwise direction L1, and allows the USB terminal CB to be inserted and removed along the lengthwise direction L1.

When seen in a plan view, the USB charger 50 is inclined so that a reference line L2 extending along the lengthwise direction (insertion/removal direction) L1 is located further outward in the vehicle width direction as it goes to the rear of the vehicle. When seen in a side view, the USB charger 50 is inclined so that the reference line L2 extending along the lengthwise direction (insertion/removal direction) L1 is located downward as it goes to the rear of the vehicle (see FIG. 2).

The cover 55 is attached to the charger main body 53 from one side in the lengthwise direction L1 (the side of the USB socket 51). The cover 55 has a bottomed cylindrical shape with a cover opening 55a on the other side in the lengthwise direction L1. The bottom portion of the cover 55 has an opening (not shown) through which the USB socket 51 passes, and a collar 56 that protrudes from the opening and surrounds the outer circumference of the USB socket 51.

An outer surface of a sidewall 55c of the cover 55 on one side in the thickness direction T1 is provided with a supported portion 57 into which a stay locking plate portion 79 provided on the support stay 75 described below is inserted. The supported portion 57 is rectangular and slightly smaller than the sidewall 55c when seen in the thickness direction T1. The supported portion 57 includes a displacement plate portion 57a that is plate-like and parallel to the sidewall 55c and spaced apart from the outside of the sidewall 55c, and a pair of leg portions 57b that are bent from both ends of the displacement plate portion 57a in the widthwise direction W1 toward the sidewall 55c and connected to the sidewall 55c. The supported portion 57 forms an insertion space 57c into which the stay locking plate portion 79 can be inserted and removed in the lengthwise direction L1. The charger assembly 50A is supported by the support stay 75 by inserting the stay locking plate portion 79 into the supported portion 57.

A locking protrusion 58 configured to lock a locking belt 62 of a cap member 60 is formed on the outer side of the displacement plate portion 57a of the supported portion 57. The cap member 60 includes a bottomed cylindrical cap main body 61 fitted onto the collar 56 of the cover 55, and the locking belt 62 extending from one side of the cap main body 61 in the radial direction. A center slit 62a that is long in the belt lengthwise direction is formed in the central portion of the locking belt 62 in the belt widthwise direction. The locking protrusion 58 includes a shaft portion 58a protruding to one side in the thickness direction T1, and an umbrella portion 58b formed by expanding the diameter of the tip of the shaft portion 58a.

The width of the center slit 62a of the locking belt 62 is the same as or slightly greater than the outer diameter of the shaft portion 58a and smaller than the outer diameter of the umbrella portion 58b. The cap member 60 including the locking belt 62 is formed of an elastic member such as rubber or the like. The locking belt 62 expands the center slit 62a through elastic deformation, allowing the umbrella portion 58b to pass to one side in the thickness direction T1. After passing through the umbrella portion 58b, the locking belt 62 recovers from elastic deformation with the shaft portion 58a inserted into the center slit 62a. Accordingly, the cap member 60 including the locking belt 62 is attached to the locking protrusion 58 so as to be movable and non-detachable along the lengthwise direction of the center slit 62a.

The connector 64 of the branch harness 64a is covered with a connector cover 65 formed of, for example, rubber. The connector cover 65 integrally includes a bottomed cylindrical covering portion 67 configured to cover the other side of the cover 55 in the lengthwise direction L1 (the side of the cover opening 55a), in addition to a bottomed cylindrical cap portion 66 configured to cover the connector 64. Waterproofing of the USB charger 50 is enhanced by attaching the cap portion 66 to the connector 64 and by attaching the covering portion 67 to the upward-facing cover opening 55a of the cover 55.

The covering portion 67 covers the side surface of the cover 55, which has the supported portion 57, until the one side in the lengthwise direction L1 (the side of the USB socket 51), and covers the side surface of the cover 55, which is opposite side of the supported portion 57, until an intermediate portion in the lengthwise direction L1. At the area of the covering portion 67 corresponding to supported portion 57, a first opening 67a through which the supported portion 57 protrudes outside the covering portion 67 is formed. At the area of the covering portion 67 which is extending along a side surface opposite to the supported portion 57, a second opening 67b through which a locking hook 59 provided on a sidewall 55d on the other side of the cover 55 in the thickness direction T1 protrudes outside the covering portion 67 is formed.

Referring to FIG. 5, the branch harness 64a is pulled out from the bottom portion of the cap portion 66 to the other side of the USB charger 50 in the lengthwise direction L1 and is routed along the rear surface (inner surface) of the right cowl 45. The branch harness 64a extends from the left side of the vehicle body to the right side of the vehicle body between the right cowl 45 and the meter device 40, and is then connected to the connector 64b on the side of the main harness between the right cowl 45 and the meter device 40.

Referring to FIG. 2, in the vehicle forward/rearward direction, the USB charger 50 is disposed between the rear end of the meter device 40 (in the embodiment, the rear lower end of the rear inclined surface 41a, where the display surface 42 is located and which faces upward toward the rear of the vehicle) P1 and the front end of the right cowl (in the embodiment, the front lower end of the lens surface of the headlight 48) P2.

Referring to FIG. 3 and FIG. 4, the USB charger 50 is disposed on the left side (outer side in the vehicle width direction) of a left outer side 41e of the meter device 40. The left outer side 41e of the meter device 40 is inclined within a predetermined width in the vehicle width direction. The USB charger 50 is entirely spaced to the left from the left outer side 41e in a direction perpendicular to the left outer side 41e when seen in a plan view and when seen in a rear view, but in the vehicle width direction, for example, the area around the coupler 54 may partially overlap with the meter device 40.

Referring to FIG. 2, the USB charger 50 is disposed so as to at least partially overlap with the meter device 40 when seen in a side view of the vehicle. The USB charger 50 is disposed to at least partially overlap with the right cowl 45 when seen in a side view of the vehicle. The connection port 51a of the tip of the USB socket 51 is disposed so as not to entirely overlap with the right cowl 45 (avoiding the right cowl 45) when seen in a side view of the vehicle.

Referring to FIG. 3 and FIG. 4, when seen in a plan view of the vehicle and when seen in a rear view, the connection port 51a of the USB socket 51 is entirely disposed inside the outer sides 47b of the right cowl 45 in the vehicle width direction (a side of a vehicle body lateral center CL) (excluding the cap member 60).

Referring to FIG. 3, an outer side 41e of the meter device 40, outside in the vehicle width direction, is inclined so that, when seen in a plan view of the vehicle, the more rear side in the vehicle is located more outward in the vehicle width direction. The USB charger 50, which is located outside the meter device 40 in the vehicle width direction, is inclined so that the lengthwise direction (insertion/removal direction) L1 is located further outward in the vehicle width direction toward the rear of the vehicle (i.e., approximately parallel to the outer side 41e of the meter device 40) when seen in a plan view of the vehicle. The USB charger 50 is disposed so that the widthwise direction W1 faces the upward/downward direction. The USB charger 50 is disposed in the thickness direction T1 with its side surface having the supported portion 57 facing inward in the vehicle width direction and toward the rear of the vehicle.

The USB charger 50 overlaps with an outer side portion 47f of the right cowl in the forward/rearward direction when seen in a plan view of the vehicle. The outer side portion 47f of the right cowl 45 is inclined and disposed further outward in the vehicle width direction as it goes to the rear of the vehicle, when seen in a plan view of the vehicle. The USB charger 50 is inclined so as to be approximately parallel to the outer side portion 47f of the right cowl 45 when seen in a plan view of the vehicle.

Referring to FIG. 2, when seen in a side view of the vehicle, at least a part of the USB charger 50 (in the first embodiment, the entirety thereof) is disposed below the upper end P3 of the meter device 40 (in the first embodiment, in which the display surface 42 is disposed and the front upper end of the rear inclined surface 41a faces upward toward the rear of the vehicle) in the vehicle upward/downward direction.

The USB charger 50 is disposed partially behind and above the display surface 42 in the normal direction V1 of the display surface 42 of the meter device 40, when seen in a side view of the vehicle.

A portion of the connection port 51a of the USB charger 50 is disposed behind and above the display surface 42 in the normal direction V1 of the display surface 42, when seen in a side view of the vehicle. The connection port 51a may be disposed behind and above the display surface 42 as a whole.

### <Support Frame 70, Support Stay 75>

Referring to FIG. 4 and FIG. 5, the meter device 40 and the right cowl 45 are fixed to the vehicle body (in the first embodiment, the steering system 4) via the same support frame 70. The support frame 70 is constructed, for example, by bending a steel plate into a predetermined shape to form a plurality of frame members, and then joining the plurality of frame members together by welding or the like. The support frame 70 includes a support plate portion 71 disposed to face a front inclined surface 41b directed toward a front lower side of the meter device 40 in the normal direction V1 of the display surface 42 and configured to support the meter device 40 from the side of the front inclined surface 41b, a pair of left and right extension plate portions 72 extending from both left and right sides of the support plate portion 71 toward left and right outer sides thereof, and a pair of left and right fixing brackets 73 coupled to front lower surfaces of the left and right extension plate portions 72 and fixed to the side of the vehicle body (for example, the top bridge 11). The support frame 70 has attachment portions for various components, such as an attachment portion for the right cowl 45 and an attachment portion for the headlight 48. Reference sign 40b in FIG. 5 indicates a meter coupler that penetrates the support plate portion 71 and is connected to the meter device 40 from the side of the front inclined surface 41b.

Referring to FIG. 5 to FIG. 8, the support stay 75 configured to support the USB charger 50 is detachably attached to the left side portion of the support frame 70 through bolt fastening. The support stay 75 is formed, for example, by bending a steel plate into a specified shape and is fixed to the left extension plate portion 72 from the front and below.

The support stay 75 includes a fastened portion 76 which abuts the front lower surfaces of the extension plate portions 72 and which is fixed to the extension plate portions 72 by a single bolt B1 and a nut N1, a support arm portion 77 having an appropriate plate width in front of the fastened portion 76, extending forward and then extending to be curved leftward (outward in the vehicle width direction), and a stay support plate portion 78 which is extending obliquely outward in the vehicle width direction and rearward from a tip of the support arm portion 77 and which is disposed along a side surface located below the USB charger 50 in the widthwise direction W1.

The outer circumference of the fastened portion 76 is provided with an anti-rotation portion 76a, which is inserted into through-holes formed at corresponding positions in the extension plate portions 72 to regulate co-rotation during bolt fastening. A resin molding M is attached to an edge of the support arm portion 77 facing the front of the vehicle. Further, in the example, although the example has been given in which the support frame 70 and the support stay 75 are originally separate bodies, the support frame 70 and the support stay 75 may also be integrally molded parts.

In addition, the support stay 75 includes a first facing plate portion 78a which extends to be bent upward from an inner side edge of the rear portion of the stay support plate portion 78 in the vehicle width direction and which is disposed along a rear portion of a side surface, facing inward in the vehicle width direction and rearward, in the thickness direction T1 of the USB charger 50 (a side surface including the supported portion 57), a second facing plate portion 78b which extends to be bent upward from an outer side extension of the stay support plate portion 78 in the vehicle width direction and which is disposed along a lower portion of a side surface, facing outward in the vehicle width direction and forward, in the thickness direction T1 of the USB charger 50, and the stay locking plate portion 79 which extends forward from the first facing plate portion 78a and which is disposed along a side surface, to which the supported portion 57 is provided, in the thickness direction T1 of the USB charger 50.

The stay locking plate portion 79 is inserted into the insertion space 57c of the supported portion 57 of the cover 55 from one side in the lengthwise direction L1 to the other side in the lengthwise direction L1. The stay locking plate portion 79 has, for example, a cutout portion 79a formed on the inner side in the plate widthwise direction so as to have a U-shape that opens toward the other side in the lengthwise direction L1.

The charger assembly 50A is supported on the support stay 75 by inserting the stay locking plate portion 79 into the supported portion 57. At both sides in the plate widthwise direction of the tip portion of the stay locking plate portion 79 on the other side in the lengthwise direction L1, there are a pair of locking claws 79b that protrude outward in the plate widthwise direction. The pair of locking claws 79b function as stoppers that respectively engage with the end portions of the pair of leg portions 57b of the supported portion 57 in a state in which the stay locking plate portion 79 is inserted into the supported portion 57.

As shown in FIG. 3, the attachment structure of the USB charger 50 in the first embodiment includes a restricting part configured to restrict the movement of the USB charger 50 in the direction of removing the USB charger 50 from the support stay 75. The restricting part of the first embodiment is constituted by an inner rib 47g of the right cowl 45. In the attachment state of the USB charger 50, a distance La between the USB charger 50 and the inner rib 47g in the lengthwise direction (insertion/removal direction) L1 is smaller than a distance Lb required for extracting the stay locking plate portion 79 from the supported portion 57. Accordingly, even if you simply try to remove the USB charger 50 from the completed vehicle, the USB charger 50 cannot be removed due to interference from the inner rib 47g of the right cowl 45, enhancing the anti-theft properties of the USB charger 50.

As described above, the motorcycle 1 of the embodiment is a saddle riding vehicle including the meter device 40 configured to display vehicle information, the right cowl 45 disposed in front of the meter device 40 and overlapping with the meter device when seen in a front view of the vehicle, and the USB charger 50 having the connection port 51a that can be connected to external equipment, the USB charger 50 being disposed between a rear end P1 of the meter device 40 and a front end P2 of the right cowl 45 in the vehicle forward/rearward direction and disposed outside the outer side 41e of the meter device 40 in the vehicle width direction, the meter device 40 and the right cowl 45 being fixed to the vehicle body via the same support frame 70, and the USB charger 50 being fixed to the support frame 70.

According to this configuration, the USB charger 50 is disposed between the meter device 40 and the right cowl 45 in the vehicle forward/rearward direction and is disposed outside the meter device 40 in the vehicle width direction, thereby achieving the following effects. By hiding the USB charger 50 in the right cowl 45, the appearance from the front of the vehicle is improved, and the USB charger 50 can be provided at a position that is easily visible to the driver. In addition, since the USB charger 50 can be fixed to the vehicle body using the common support frame 70 that supports the meter device 40 and the right cowl 45 without requiring a separate fixing bracket, the USB charger 50 can be provided without increasing the number of parts, and the USB charger 50 can be provided around the meter device 40 and the right cowl 45 efficiently and compactly.

In the motorcycle 1, the USB charger 50 at least partially overlaps with the meter device 40 when seen in a side view of the vehicle.

According to this configuration, by arranging the USB charger 50 and the meter device 40 to overlap each other when seen in a side view, the USB charger 50 can be arranged around the meter device 40 while keeping the areas around the USB charger 50 and the meter device 40 compact in the vehicle forward/rearward direction and the upward/downward direction.

In the motorcycle 1, the connection port 51a of the USB charger 50 is disposed inside the outer sides 47b of the right cowl 45 in the vehicle width direction when seen in a plan view of the vehicle.

According to this configuration, the connection port 51a of the USB charger 50 is disposed inward from the right cowl 45 in the vehicle width direction, so that the right cowl 45 can prevent water or dust from getting into the connection port 51a.

In the motorcycle 1, when seen in a side view of the vehicle, at least a part of the USB charger 50 overlaps with the right cowl 45, and the connection port 51a does not overlaps with the right cowl 45.

According to this configuration, since the USB charger 50 overlaps with the right cowl 45 when seen in a side view of the vehicle, the USB charger 50 is made less noticeable and the appearance of the surrounding area is improved, and since the connection port 51a of the USB charger 50 does not overlap with the right cowl 45 when seen in a side view of the vehicle, the connection port 51a can be more easily recognized by the user, thereby improving operability when inserting and removing a cable CA of the external equipment.

The motorcycle 1 includes a restricting part (the inner rib 47g) configured to restrict the movement of the USB charger 50 in a direction to remove the USB charger 50 from the support stay 75.

According to this configuration, by restricting the movement of the USB charger 50 in the direction of removing the USB charger 50 from the support stay 75, it becomes more difficult to remove the USB charger 50 from the vehicle and the anti-theft properties of the main body of the USB charger 50 can be improved.

In the motorcycle 1, the outer side 41e of the meter device 40 on the outer side in the vehicle width direction is inclined to be disposed further outward in the vehicle width direction as it goes to the rear of the vehicle, when seen in a plan view of the vehicle, and the USB charger 50 located on the outer side in the vehicle width direction of the meter device 40 is inclined so that the insertion/removal direction L1 of the external equipment relative to the connection port 51a is positioned further outward in the vehicle width direction as it goes to the rear of the vehicle, when seen in a plan view of the vehicle.

According to this configuration, by inclining both the outer side 41e of the meter device 40 and the insertion/removal direction L1 of the USB charger 50 so that they are positioned further outward in the vehicle width direction toward the rear of the vehicle, the USB charger 50 is disposed along the outer side 41e of the meter device 40 (to be parallel to the outer side 41e), making it easier to insert and remove the cable CA of the external equipment into the USB charger 50.

In the motorcycle 1, the restricting part is provided on the right cowl 45. According to this configuration, the restricting part configured to restrict the removal of the USB charger 50 is provided on the right cowl 45, which improves the anti-theft properties of the main body of the USB charger 50 without increasing the number of parts.

In the motorcycle 1, when seen in a side view of the vehicle, the USB charger 50 is located below an upper end P3 of the meter device 40 in the vehicle upward/downward direction, and at least a part of the USB charger 50 is disposed on the side of the display surface 42 facing upward and rearward of the vehicle in the normal direction V1 of the display surface 42, with reference to the display surface 42 of the meter device 40.

According to this configuration, by disposing the USB charger 50 below the upper end P3 of the meter device 40, the USB charger 50 can be protected from disturbances from above without the need for additional parts, and by disposing the USB charger 50 above and behind the display surface 42, the USB charger 50 is closer to the occupant side, improving user accessibility.

In the motorcycle 1, at least a part of the connection port 51a of the USB charger 50 is disposed at rear and above of the display surface 42 in the normal direction V1 when seen in a side view of the vehicle.

According to this configuration, by disposing the connection port 51a of the USB charger 50 at rear and above of the display surface 42, the connection port 51a is disposed on the occupant side of the display surface 42, thereby improving the visibility and user accessibility of the connection port 51a.

In the motorcycle 1, the USB charger 50 is connected to a harness 64a connected to the in-vehicle power supply, and the harness 64a is routed along the rear surface of the right cowl 45 in the vehicle width direction and then coupled another harness in front of the meter device 40.

According to this configuration, the harness 64a, which connects the USB charger 50 and the power supply, extends between the right cowl 45 and the meter device in the vehicle width direction and is connected to the other harness in front of the meter device 40, making it possible to effectively utilize the limited space in the saddle riding vehicle and route the power supply harness 64a, which is connected to the USB charger 50.

### Second Embodiment

Hereinafter, a second embodiment of the present invention will be described with reference to the accompanying drawings.

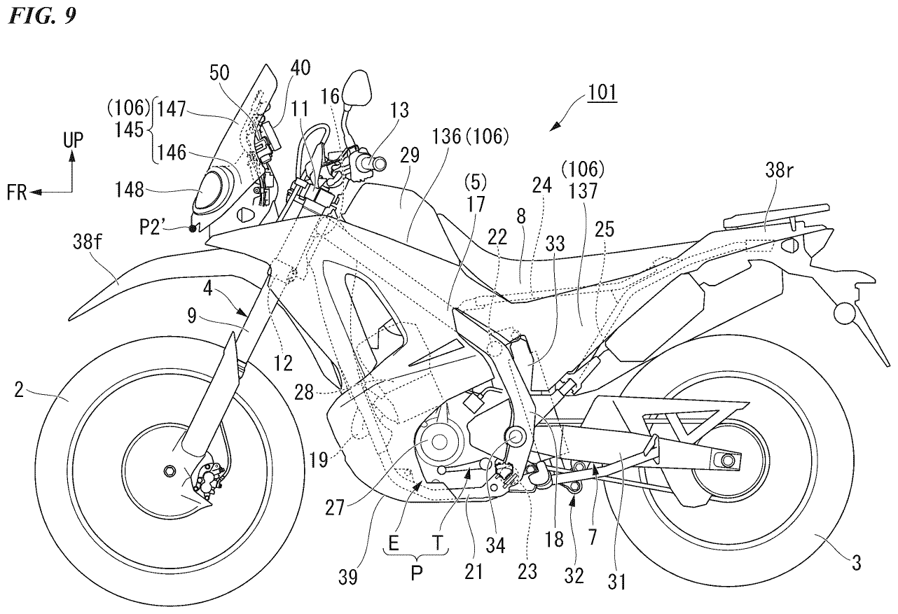

FIG. 9 is a left side view of a motorcycle (saddle riding vehicle) 101 of a second embodiment.

As shown in FIG. 9, the motorcycle 101 of the second embodiment is an off-road type saddle riding vehicle, like the first embodiment. The motorcycle 101 has a large up and down stroke amount of the wheel, a large ground clearance of the vehicle body, a small and lightweight vehicle body, and a good mass concentration of the vehicle body.

The motorcycle 101 includes a front wheel 2, a rear wheel 3, a front wheel suspension system 4, a vehicle body frame 5, a vehicle body cover 106, a rear wheel suspension system 7, and a power unit P.

The front wheel suspension system 4 includes a pair of left and right front forks 9 configured to axially support the front wheel 2 on lower end portions thereof, a top bridge 11 and a bottom bridge 12 provided to bridge between upper portions of the pair of front forks 9, and a stem pipe (not shown) provided to bridge between the top bridge 11 and the bottom bridge 12 and inserted through a head pipe 16. The front wheel 2 is steerably supported on the head pipe 16 of the vehicle body frame 5 via the front wheel suspension system 4. A bar type steering handle 13 is supported on the top bridge 11. Hereinafter, the front wheel suspension system 4 may be referred to as the steering system 4.

The vehicle body frame 5 includes the head pipe 16, a pair of left and right main frames 17, a pair of left and right pivot frames 18, a single down frame 19, a pair of left and right lower frames 21, a cross member 22 configured to connect upper portions of the left and right pivot frames 18, and a lower cross member 23 configured to connect lower portions of the left and right pivot frames 18, which are integrally coupled to each other through welding or the like.

The vehicle body frame 5 further includes a pair of left and right seat rails 24 extending rearward from the upper portions of the left and right pivot frames 18, and a pair of left and right support rails 25 extending rearward and upward from vertical intermediate portions of the left and right pivot frames 18. Rear end portions of the left and right support rails 25 are coupled to rear portions of the left and right seat rails 24 on the same sides from below. The left and right seat rails 24 are appropriately connected by a cross frame. The left and right seat rails 24 and the left and right support rails 25 are integrally coupled through welding or the like, and constitute a seat frame configured to support the seat 8 on which an occupant sits.

A pivot shaft 34 extending in the vehicle width direction bridges between vertical intermediate portions of the left and right pivot frames 18. An upper end portion of the rear cushion 33 is connected to the cross member 22 between the upper portions of the left and right pivot frames 18. A link mechanism 32 is connected to the lower cross member 23 between the lower portions of the left and right pivot frames 18.

The vehicle body frame 5 is equipped with a power unit P that is a prime mover of the motorcycle 101 in an area surrounded by the main frames 17, the pivot frames 18, the down frame 19 and the lower frames 21 when seen in a side view.

The vehicle body cover 106 covers the vehicle body frame 5 and the like. The vehicle body cover 106 includes a pair of left and right front side cowls 136, a pair of left and right rear side cowls 137, an engine cover 39 configured to cover surroundings of the engine E, and a right cowl 145 in front of the handle 13.

The left and right front side cowls 136 are disposed from positions below both left and right sides of the front portion of the seat 8 to positions overlapping with the upper portion of the down frame 19, when seen in a side view in the vehicle width direction. The left and right front side cowls 136 extend flared forward from below the front portion of seat 8 when seen in a side view. At least one of the left and right front side cowls 136 functions as an air guide plate (radiator shroud) to a radiator supported on a side portion of the down frame 19.

The left and right rear side cowls 137 are disposed at positions below both left and right sides of the rear portion of the seat 8, respectively, when seen in a side view. The side cowls are provided to cover the seat frame from the outer side in the vehicle width direction. The rear fender 38r extends rearward behind the seat 8. The rear fender 38r is disposed above the rear wheel 3 with an interval. Reference sign 38f in the drawings indicates a front fender disposed above the front wheel 2 with an interval and supported on the bottom bridge 12. The engine cover 39 is disposed to cover a range extending downward from the front of the crank case 27 and a range extending from the front of the crank case 27 to the left and right sides of the cylinders 28. The right cowl 145 will be described below in detail.

The rear wheel suspension system 7 includes the swing arm 31 configured to axially support the rear wheel 3 on a rear end portion thereof, the link mechanism 32 configured to connect the front portion of the swing arm 31 and the lower cross member 23, and the rear cushion 33 that bridges between the link mechanism 32 and the cross member 22.

The swing arm 31 disposed below the rear portion of the vehicle body and extends in the forward/rearward direction. The front end portion of the swing arm 31 is vertically swingably supported on the pair of pivot frames 18 via the pivot shaft 34.

The link mechanism 32 appropriately connects the front portion of the swing arm 31, the lower cross member 23 and the lower end portion of the rear cushion 33, and changes a ratio of a stroke of the rear cushion 33 with respect to the stroke of the rear wheel 3.

The power unit P includes an engine (internal combustion engine) E that is a driving source, and a transmission T. The engine E is, for example, a single cylinder engine having a crankshaft parallel to the vehicle width direction (leftward/rightward direction). A lower portion of the engine E constitutes the crank case 27. The cylinder 28 is provided upright above the front portion of the crank case 27. The transmission T is accommodated in the rear portion of the crank case 27.

A fuel tank 29 is provided between the left and right main frames 17 above the cylinder 28. A front portion of the seat 8 rides on an upper surface of the rear portion of the fuel tank 29.

### <Meter Device 40>

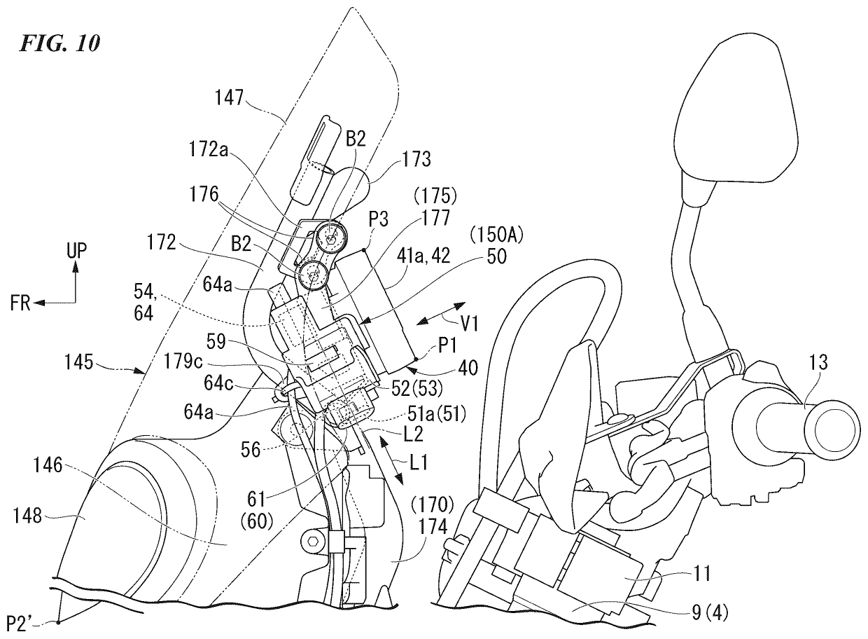

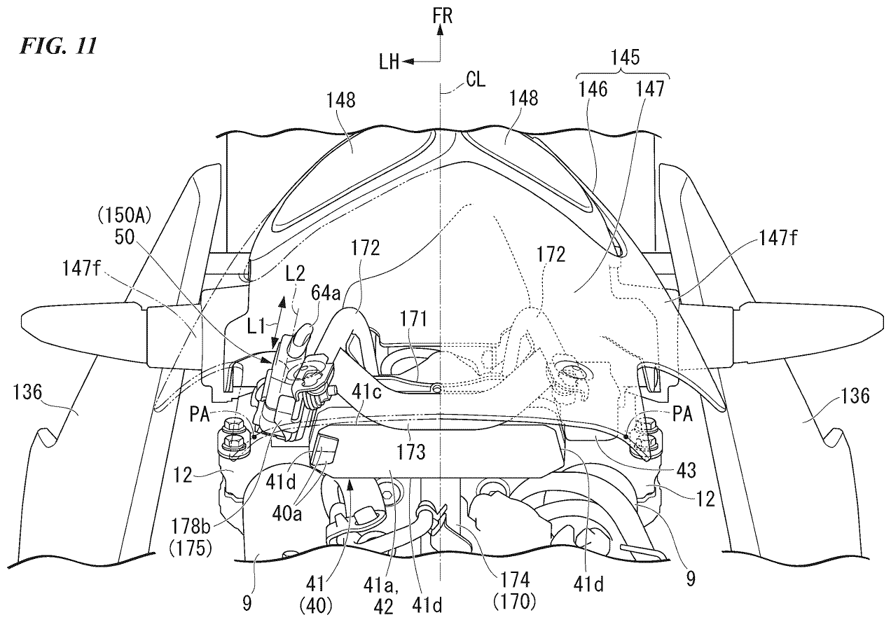

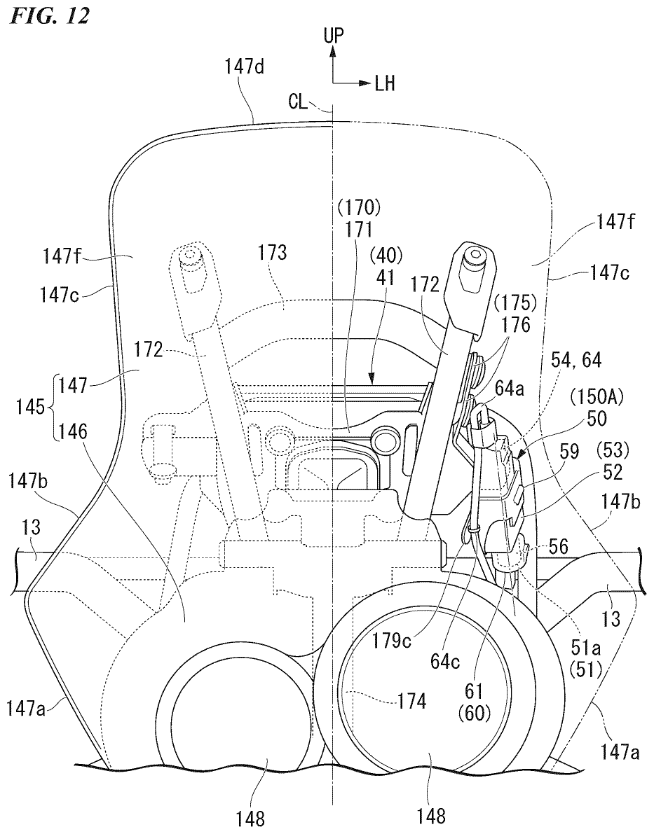

FIG. 10 is a left side view of an area including the right cowl 145 and the meter device 40 of the motorcycle 101. FIG. 11 is a plan view of the area including the right cowl 145 and the meter device 40. FIG. 12 is a rear view of the area including the right cowl 145 and the meter device 40.

As shown in FIG. 10 to FIG. 12, the meter device 40 is provided at a front upper side of the top bridge 11 to display vehicle information such as a vehicle speed or the like to the occupant.

The meter device 40 has a housing 41 that has a generally rectangular parallelepiped appearance that is long in the leftward/rightward direction. The meter device 40 has a rectangular display surface 42 which is slightly smaller than the housing 41 on a substantially rectangular side surface (hereinafter referred to as the rear inclined surface 41a) facing rearward and upward. The housing 41 has a thickness direction V1 that is the normal direction of the display surface 42 (shown by an arrow V1 in the drawings), and is flattened with a reduced width in the thickness direction V1. The display surface 42 can display various pieces of vehicle information using, for example, a liquid crystal panel. An upper portion of the display surface 42 has a plurality of indicator lamps arranged side by side. An operation button 40a configured to operate the display on the display surface 42 is provided on the rear inclined surface 41a to the left of the display surface 42. A switch button 43 is provided to the right of the right outer side 41e of the meter device 40, for example, to activate the anti-lock brake system (ABS) or to switch engine output characteristics or the like.

Referring to FIG. 11, when seen in the normal direction V1, the meter device has the upper side 41c and the lower side 41d along the leftward/rightward direction, and the pair of left and right outer sides 41e located outside the leftward/rightward direction. The left and right outer sides 41e are inclined to be located further outward in the vehicle width direction as they go downward. That is, the meter device 40 has a trapezoidal outer shape when seen in the normal direction V1. The meter device 40 of the second embodiment is located higher in the vehicle upward/downward direction than in the first embodiment, and the standing angle of the rear inclined surface 41a with respect to the horizontal surface is larger than in the first embodiment.

### <Right Cowl 145>

As shown in FIG. 10 to FIG. 12, the right cowl 145 configured to cover a range from surroundings and above a headlight 148 is provided in front of the meter device 40.

The right cowl 145 integrally includes a right cover 146 configured to cover surroundings of the headlight 148 when seen in a front view, and a windscreen 147 which extends above the right cover 146, which is configured to cover the meter device from the front and which stands in front of a boarding position. The right cowl 145 in the second embodiment is entirely made of a transparent or translucent synthetic resin. The right cowl 145 is attached to a support frame 170 supported on the head pipe 16 of the vehicle body frame 5 together with the two-eyed headlight 148 and the meter device 40. The right cowl 145, the headlight 148 and the meter device 40 are fixedly supported on the vehicle body frame 5 independently from the steering system 4.

Referring to FIG. 12, the right cowl 145 is located in front of the meter device and is provided to overlap with the entire meter device 40 when seen in a front view of the vehicle (when seen in a front view). The right cowl 145 includes a pair of left and right lower portion outer sides 147a obliquely extending outward in the vehicle width direction and upward from a lower end side of the headlight 148, a pair of left and right middle row outer sides 147b obliquely extending inward in the vehicle width direction and upward from outer side ends of the lower portion outer sides 147a in the vehicle width direction, a pair of left and right upper portion outer sides 147c extending more steeply outward in the vehicle width direction and upward from upper ends of the left and right middle row outer sides 147b than the lower portion outer sides 147a, and the upper side 47d extending substantially horizontally between upper ends of the left and right upper portion outer sides 147c when seen in a front view of the vehicle.

Referring to FIG. 11, the right cowl 145 is a curved portion protruding toward the front of the vehicle when seen from above. Left and right outer side portions of the right cowl 145 have a large rearward curvature. For example, when seen in a plan view of the vehicle, the tangential line of the outer surface of the right cowl 145 is in the range outside in the vehicle width direction of a point PA in FIG. 11, and a rearward inclination angle in the leftward/rightward direction is 30 degrees or more. For example, the area outside in the vehicle width direction of the line connecting the point PA above and below the right cowl 145 is considered to be a cowl outer side portion 147f, which is inclined to be located rearward as it goes outward in the vehicle width direction when seen from above.

### <USB Charger 50>

As shown in FIG. 10 to FIG. 12, the USB charger 50 having the connection port 51a that can be connected to the external equipment is provided behind the right cowl 145 and on a left side of the meter device 40. The USB charger 50 integrally includes the transformer (DC-DC converter) 52 and the USB socket 51. The USB charger 50 can be connected to external electrical equipment such as a smart phone or the like by a universal serial bus (USB) connector. The USB charger 50 transforms the electric power of the in-vehicle battery from 12V to 5V, enabling it to supply electric power to and charge external equipment. The USB socket 51 of the USB charger 50, together with the USB terminal CB provided at the tip portion of the power supply cable CA on the external equipment side, constitutes the USB connector.

The USB socket 51 in the embodiment is provided with at least a terminal for power supply, but may not be provided with a terminal for data communication. If a USB socket for communicating with the control device of motorcycle 101 is provided in place of the USB socket 51, the USB socket will have a terminal for data communication and will be connected to the data communication line on the vehicle body side. The USB socket 51 may be used not only for power supply but also as an equipment connecting part capable of electrically connecting external electrical equipment.

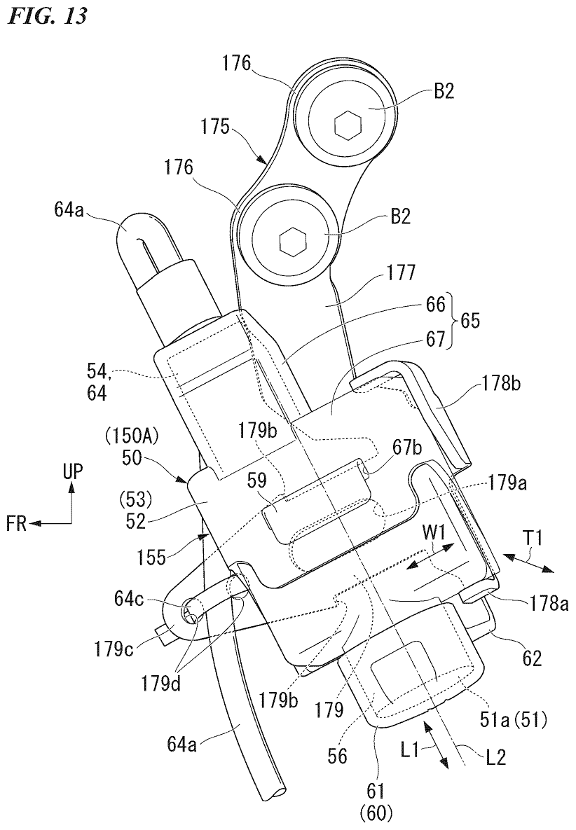

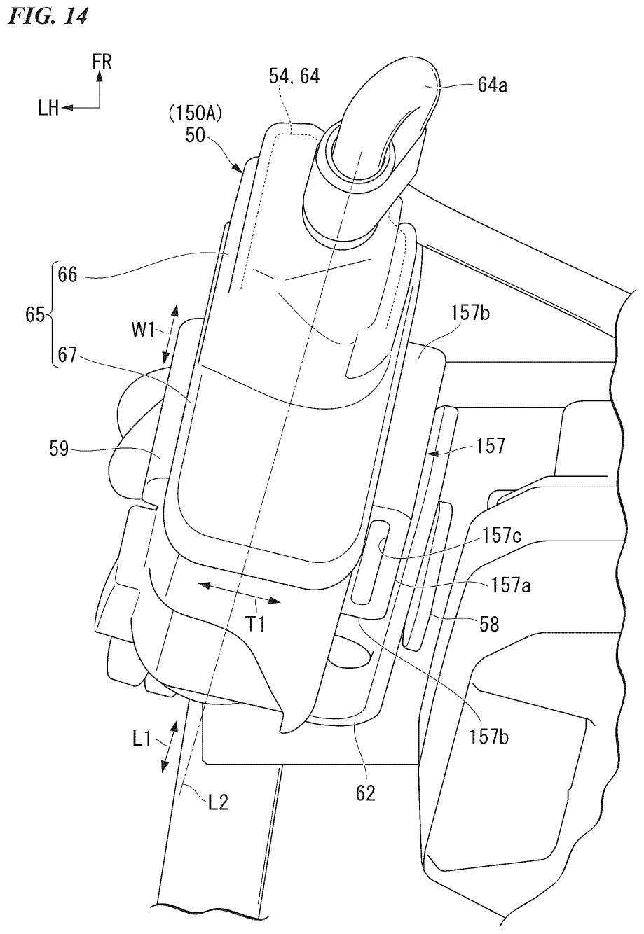

FIG. 13 is a left side view of a charger assembly 150A of the second embodiment. FIG. 14 is a plan view of the charger assembly 150A of the second embodiment.

Referring to FIG. 13 and FIG. 14 and incorporating FIG. 8, the USB charger 50 is formed by integrating the charger main body 53 including the transformer 52 with the USB socket 51, and by mounting, for example, a resin cover 155 to form the charger assembly 150A. The charger assembly 150A is attached to a tip portion of a support stay 175. A base end portion of the support stay 175 is attached to the support frame 170 configured to support the meter device 40 and the right cowl 145 on the head pipe 16.

The charger main body 53 has a flat rectangular parallelepiped appearance with a reduced width in the thickness direction (indicated by an arrow T1 in the drawings). The USB socket 51 protrudes from a central portion of one side (hereinafter referred to as the first side 53a) of the charger main body 53 when seen in the thickness direction T1. At the tip of the USB socket 51, there is an opening for the connection port 51a to which the USB terminal CB for external equipment can be connected.

When the charger main body 53 is seen in the thickness direction T1, the coupler 54 protrudes from the second side 53b which is opposite to the first side 53a. The coupler 54 is protrudingly provided at a position offset toward one end of the second side 53b. The connector 64 of the branch harness 64a, which leads to the main harness on the vehicle body side, can be connected to the coupler 54. The USB charger 50 can be connected to the in-vehicle power supply (battery) through the branch harness 64a, the main harness, and the like. Hereinafter, when the charger main body 53 is seen in the thickness direction T1, a direction perpendicular to the first side 53a and the second side 53b is referred to as a lengthwise direction L1, and a direction along the first side 53a and the second side 53b is referred to as a widthwise direction W1. The USB socket 51 protrudes from the first side 53a to one side in the lengthwise direction L1, and allows the USB terminal CB of the external equipment to be inserted and removed in the lengthwise direction L1. The lengthwise direction L1 is also an insertion/removal direction of the USB terminal CB. The coupler 54 protrudes from the second side 53b to the other side in the lengthwise direction L1, and allows the USB terminal CB to be inserted and removed in the lengthwise direction L1.

When seen in a plan view, the USB charger 50 is inclined so that the reference line L2 along the lengthwise direction (insertion/removal direction) L1 is located further outward in the vehicle width direction toward the rear of the vehicle. When seen in a side view, the USB charger 50 is inclined so that the reference line L2 along the lengthwise direction (insertion/removal direction) L1 is located downward toward the rear of the vehicle (see FIG. 10).

The cover 155 is mounted on the charger main body 53 from one side in the lengthwise direction L1 (the side of the USB socket 51). The cover 155 has a bottomed cylindrical shape with the cover opening 55a on the other side in the lengthwise direction L1. A bottom portion 55b of the cover 155 has an opening (not shown) through which the USB socket 51 passes, and also has the collar 56 that protrudes from the opening and surrounds the outer circumference of the USB socket 51.

An outer surface of the sidewall 55c on one side of the cover 155 in the thickness direction T1 is provided with a supported portion 157 into which a stay locking plate portion 179 provided in the support stay 175 is inserted, which will be described below. The supported portion 157 is rectangular and slightly smaller than the sidewall 55c when seen in the thickness direction T1. The supported portion 157 includes a displacement plate portion 157a which is plate-like and parallel to the sidewall 55c and spaced apart from the outside of the sidewall 55c, and a pair of leg portions 157b which are bent from both ends of the displacement plate portion 157a in the lengthwise direction L1 toward the sidewall 55c and connected to the sidewall 55c. The supported portion 157 forms an insertion space 157c into which the stay locking plate portion 179 can be inserted and removed in the widthwise direction W1. The cover 155 has the supported portion 157 oriented in a different direction from that of the cover 55 of the first embodiment. The charger assembly 150A is supported on the support stay 175 by inserting the stay locking plate portion 179 into the supported portion 157.

The locking protrusion 58 configured to engage the locking belt 62 of the cap member 60 is formed on an outer side of the displacement plate portion 157a of the supported portion 157. The cap member 60 includes a bottomed cylindrical cap main body 61 fitted onto a collar of the cover 155, and a locking belt 62 radially extending from one side of the cap main body 61 in the radial direction. The locking belt 62 has a center slit 62a formed in a central portion in the belt widthwise direction, which is long in the belt lengthwise direction. The locking protrusion 58 has a shaft portion 58a protruding to one side in the thickness direction T1, and an umbrella portion 58b formed by expanding the diameter of the tip of the shaft portion 58a.

The width of the center slit 62a of the locking belt 62 is the same as or slightly greater than the outer diameter of the shaft portion 58a and smaller than the outer diameter of the umbrella portion 58b. The cap member 60 including the locking belt 62 is formed of an elastic member such as rubber or the like. The locking belt 62 expands the center slit 62a through elastic deformation, allowing the umbrella portion 58b to pass to one side in the thickness direction T1. After the locking belt 62 passes through the umbrella portion 58b, the elastic deformation is recovered, causing the shaft portion 58a to fit into the center slit 62a. Accordingly, the cap member 60 including the locking belt 62 is attached to the locking protrusion 58 so as to be movable along the lengthwise direction of the center slit 62a while being unable to come off.

The connector 64 of the branch harness 64a is covered with the connector cover 65 formed of, for example, rubber or the like. The connector cover 65 integrally includes, in addition to the bottomed cylindrical cap portion 66 that covers the connector 64, the bottomed cylindrical covering portion 67 that covers the other side of the cover 155 in the lengthwise direction L1 (the side of the cover opening 55a). Waterproofing of the USB charger 50 is enhanced by attaching the cap portion 66 to the connector 64 and by attaching the covering portion 67 to the upward-facing cover opening 55a of the cover 155.

The covering portion 67 covers the side surface of the cover 155, which has the supported portion 157, until the one side in the lengthwise direction L1 (the side of the USB socket 51), and covers the side surface of the cover 155, which is opposite side of the supported portion 157, until the intermediate portion in the lengthwise direction L1. The first opening 67a through which the supported portion 157 protrudes toward an outer side of the covering portion 67 is formed in an area of the covering portion 67 corresponding to the supported portion 157. The second opening 67b through which the locking hook 59 provided on the sidewall 55d on the other side of the cover 155 in the thickness direction T1 is inserted to protrude to the outer side of the covering portion 67 is formed in an area along the side surface of the covering portion 67 which is opposite side of the supported portion 157.

The branch harness 64a is pulled out from the bottom portion of the cap portion 66 to the other side in the lengthwise direction L1 of the USB charger 50 (upward in the second embodiment), and then folded back to the other side (lower side) in the lengthwise direction L1 and is fixed with a wiring tape or the like. The branch harness 64a, which is folded back to the other side (lower side) in the lengthwise direction L1, extends downward along the front side of the USB charger 50 and is connected to a connector (not shown) on the side of the main harness. A tip portion 179c of the stay locking plate portion 179, which has passed through the supported portion 157, is disposed in front of the USB charger 50, and the branch harness 64a is held by the tip portion 179c via a resin grip 64c.

The USB charger 50 is disposed between a rear end (in the second embodiment, a rear lower end of the rear inclined surface 41a at which the display surface 42 is disposed and facing toward a rear upper side of the vehicle) P1 of the meter device 40 and a front end (front lower end, see FIG. 9) P2′ of the right cowl 145 in the vehicle forward/rearward direction. The USB charger 50 is disposed on a left side of the left outer side 41e of the meter device 40 (an outer side in the vehicle width direction). The left outer side 41e of the meter device 40 is inclined within a predetermined width in the vehicle width direction. The USB charger 50 is entirely spaced to the left from the left outer side 41e in a direction perpendicular to the left outer side 41e when seen in a plan view and when seen in a rear view, but in the vehicle width direction, for example, the area around the coupler 54 may partially overlap the meter device 40.

Referring to FIG. 10, the USB charger 50 is disposed to at least partially overlap with the meter device 40 when seen in a side view of the vehicle. The USB charger 50 is disposed to at least partially overlap with the right cowl 145 when seen in a side view of the vehicle. The connection port 51a of the tip of the USB socket 51 is disposed not to entirely overlap with the right cowl 145 (to avoid the right cowl 145) when seen in a side view of the vehicle.

Referring to FIG. 11 and FIG. 12, the connection port 51a of the USB socket 51 is disposed entirely on an inner side of the middle row outer sides 147b and the upper portion outer sides 147c of the right cowl 145 (on the side of a vehicle body lateral center CL) in the vehicle width direction.

The outer side 41e of the meter device 40 in the vehicle width direction is inclined to be located outward to the rear of the vehicle in the vehicle width direction when seen in a plan view of the vehicle. The USB charger 50 located on the outer side of the meter device 40 in the vehicle width direction is inclined such that the lengthwise direction (insertion/removal direction) L1 is located outward as it goes to the rear of the vehicle in the vehicle width direction (i.e., substantially parallel to the outer side 41e of the meter device 40) when seen in a plan view of the vehicle. The USB charger 50 is disposed so that the widthwise direction W1 faces the forward/rearward direction. The USB charger 50 is disposed in the thickness direction T1 with the side surface having the supported portion 157 facing inward in the vehicle width direction.

The USB charger 50 overlaps with an outer side portion 147f of the right cowl 145 in the forward/rearward direction when seen in a plan view of the vehicle. The outer side portion 147f of the right cowl 145 is inclined to be located outward in the vehicle width direction as it goes to the rear when seen in a plan view of the vehicle. The USB charger 50 is inclined substantially parallel to the outer side portion 147f of the right cowl 145 when seen in a plan view of the vehicle.

When seen in a side view of the vehicle, at least a part (in the second embodiment, the entirety) of the USB charger 50 is located below the upper end (in the second embodiment, where the display surface 42 is disposed and the front upper end of the rear inclined surface 41a facing upward toward the rear of the vehicle) P3 of the meter device 40 in the vehicle upward/downward direction.

When seen in a side view of the vehicle, at least a part of the USB charger 50 (in the second embodiment, the entirety) is disposed in front of and below the display surface 42 in the normal direction V1 of the display surface 42 of the meter device 40.

At least a portion (in the second embodiment, the entirety) of the connection port 51a of the USB charger 50 is disposed so as to be located below the lower end (the lower side 41d) of the meter device 40 in the vehicle upward/downward direction.

### <Support Frame 170, Support Stay 175>

Referring to FIG. 10 to FIG. 12, the meter device 40 and the right cowl 145 are fixed to the vehicle body (in the second embodiment, the head pipe 16) via the same support frame 170. The support frame 170 is, for example, constituted by joining multiple types of steel members together by welding or the like. The support frame 170 includes a support plate portion 171 which is disposed to face the front inclined surface 41b directed forward and downward in the normal direction V1 of the display surface 42 of the meter device 40 and which is configured to support the meter device 40 from the side of the front inclined surface 41b, a pair of left and right screen support portions 172 which is extending upward from both left and right sides of the support plate portion 171 and which is configured to support a vertical intermediate portion of the windscreen 147, an accessory bar 173 which bridges between the left and right screen support portions 172 and which is able to be attached to the external equipment, and a support frame leg portion 174 which is extending downward from the support plate portion 171 and which is fixed to the head pipe 16. The support frame 170 is provided with attachment portions of various parts, such as an attachment portion of the right cowl 145, an attachment portion of the shroud, an attachment portion of the headlight 148, and the like.

The support stay 175, which supports the USB charger 50, is removably attached to the left side portion of the support frame 170 by bolt fastening. The support stay 175 is formed, for example, by bending a steel plate into a predetermined shape and is fixed from the outside in the vehicle width direction to a fastening bracket 172a that is fixed to a left screen support portion 172.

The support stay 175 includes a fastened portion 176 which abuts the outer side surface of the fastening bracket 172a and which is fastened to the fastening bracket 172a by a pair of bolt B2 and nut (not shown), a support arm portion 177 which has an appropriate plate width below the fastened portion 176, which is extending downward and then displaced rearward to extend further downward, and the stay locking plate portion 179 which is obliquely extending forward and downward from the lower portion of the support arm portion 177 and which is disposed along the side surface including the supported portion 157 of the USB charger 50 in the thickness direction T1. Further, the support stay 175 and the support frame 170 are not limited to being separate bodies, and may be integrally molded parts.

In addition, the support stay 175 includes a first locking protrusion 178a which is bent and extending outward from the lower end of the support arm portion 177 in the vehicle width direction and which is disposed near the USB socket 51 to abut an end surface on one side of the USB charger 50 in the lengthwise direction L1, and an L-shaped second locking protrusion 178b which is bent outward in the vehicle width direction of the vertical intermediate portion of the support arm portion 177 and which is configured to abut a side surface on a rear side of the vehicle in the widthwise direction W1 and an end surface on an upper side in the lengthwise direction L1 of the USB charger 50.

The stay locking plate portion 179 is inserted into the insertion space 157c of the supported portion 157 of the cover 155 from one side in the widthwise direction W1 to the other side in the widthwise direction W1. The stay locking plate portion 179 forms, for example, an oval-shaped through-hole 179a in an inner region in the plate widthwise direction. The charger assembly 150A is supported by the support stay 175 by inserting the stay locking plate portion 179 into the supported portion 157. On the other side of the stay locking plate portion 179 in the widthwise direction W1, a pair of locking claws 179b protruding outward in the plate widthwise direction are provided in areas on both sides in the plate widthwise direction. The pair of locking claws 179b function as stoppers that respectively engage with the end portions of the pair of leg portions 157b of the supported portion 157 in a state in which the stay locking plate portion 179 is inserted into the supported portion 157. An attachment hole 179d for the resin grip 64c that holds the branch harness 64a is formed in the tip portion 179c on the other side of the stay locking plate portion 179 in the widthwise direction W1.

Referring to FIG. 13, the attachment structure of the USB charger 50 of the second embodiment includes a restricting part configured to restrict movement of the USB charger 50 in the direction of removing the USB charger 50 from the support stay 175. The restricting part of the second embodiment constitutes the resin grip 64c attached to the tip portion 179c of the stay locking plate portion 179. In the attachment state of the USB charger 50, the resin grip 64c protruding from the stay locking plate portion 179 is disposed on one side of the USB charger 50 in the widthwise direction W1. For this reason, even if it is simply tried to remove the USB charger 50 from the completed vehicle, it will not be possible to remove the USB charger 50 due to the interference of the resin grip 64c, enhancing the anti-theft properties of the USB charger 50.

As described above, the motorcycle 101 of the embodiment is the saddle riding vehicle includes the meter device 40 configured to display vehicle information, the right cowl 145 disposed in front of the meter device 40 and overlapping with the meter device when seen in a front view of the vehicle, and the USB charger 50 having the connection port 51a that can be connected to external equipment, the USB charger 50 is disposed between the rear end P1 of the meter device 40 and the front end P2′ of the right cowl 145 in the vehicle forward/rearward direction and outside the outer side 41e of the meter device 40 in the vehicle width direction, the meter device 40 and the right cowl 145 are fixed to the vehicle body via the same support frame 170, and the USB charger 50 is fixed to the support frame 170.

According to this configuration, the USB charger 50 is disposed between the meter device 40 and the right cowl 145 in the vehicle forward/rearward direction and outside the meter device 40 in the vehicle width direction, thereby achieving the following effects. By hiding the USB charger 50 in the right cowl 145, the appearance from the front of the vehicle is improved, and the USB charger 50 can be provided at a position that is easily visible to the driver. In addition, since the USB charger 50 can be fixed to the vehicle body using the common support frame 170 that supports the meter device 40 and the right cowl 145 without requiring a separate fixing bracket, the USB charger 50 can be provided without increasing the number of parts, and the USB charger 50 can be provided around the meter device 40 and the right cowl 145 efficiently and compactly.

In the motorcycle 101, the USB charger 50 at least partially overlaps with the meter device 40 when seen in a side view of the vehicle.

According to this configuration, by arranging the USB charger 50 and the meter device 40 to overlap with each other when seen in a side view, the USB charger 50 can be disposed around the meter device 40 while keeping the areas around the USB charger 50 and the meter device 40 compact in the vehicle forward/rearward direction and the upward/downward direction.

In the motorcycle 101, the connection port 51a of the USB charger 50 is disposed inside the outer sides 147b and 147c of the right cowl 145 in the vehicle width direction when seen in a plan view of the vehicle.

According to this configuration, by disposing the connection port 51a of the USB charger 50 on the inner side of the right cowl 145 in the vehicle width direction, the right cowl 145 can prevent water or dust from getting into the connection port 51a.

In the motorcycle 101, when seen in a side view of the vehicle, at least a part of the USB charger 50 overlaps with the right cowl 145, and the connection port 51a does not overlap with the right cowl 145.

According to this configuration, since the USB charger 50 partially overlaps with the right cowl 145 when seen in a side view of the vehicle, the appearance around the USB charger 50 can be improved, and since the connection port 51a of the USB charger 50 does not overlap with the right cowl 145 when seen in a side view of the vehicle, operability can be improved when a user inserts or removes the cable CA of the external equipment into the connection port 51a.

The motorcycle 101 includes the restricting part (the resin grip 64c) configured to restrict movement of the USB charger 50 in the direction of removing the USB charger 50 from the support stay 175.

According to this configuration, by restricting the movement of the USB charger 50 in the direction of removing the USB charger 50 from the support stay 175, it becomes difficult to remove the USB charger 50 from the vehicle and the anti-theft properties of the main body of the USB charger 50 can be improved.

In the motorcycle 101, the outer side 41e of the meter device 40 in the vehicle width direction is inclined to be located outward toward the rear of the vehicle in the vehicle width direction when seen in a plan view of the vehicle, and the USB charger 50 located on the outer side of the meter device 40 in the vehicle width direction is inclined so that the insertion/removal direction L1 of the external equipment with respect to the connection port 51a is located outward toward the rear of the vehicle in the vehicle width direction when seen in a plan view of the vehicle.

According to this configuration, by inclining both the outer side 41e of the meter device 40 and the insertion/removal direction L1 of the USB charger 50 to be located further outward in the vehicle width direction toward the rear of the vehicle, the USB charger 50 is disposed along the outer side 41e of the meter device 40 (to be parallel to the outer side 41e), making it easier to insert and remove the cable CA of the external equipment into the USB charger 50.

In the motorcycle 101, when seen in a side view of the vehicle, the USB charger 50 is located below the upper end P3 of the meter device 40 in the vehicle upward/downward direction, and at least a part of the USB charger 50 is disposed on the side of the display surface 42 facing forward and downward of the vehicle in the normal direction V1 of the display surface 42 of the meter device 40 with reference to the display surface 42 of the meter device 40.

According to this configuration, by disposing the USB charger 50 below the upper end P3 of the meter device 40, the USB charger 50 can be protected from disturbances from above without requiring any additional parts, and by disposing the USB charger 50 in front of and below the display surface 42, the USB charger 50 can be disposed compactly between the meter device 40 and the vehicle body cover 106.

In the motorcycle 101, when seen in a side view of the vehicle, at least a part of the USB charger 50 overlaps with the meter device 40, and the connection port 51a is located below a lower end 41d of the meter device 40 in the vehicle upward/downward direction.

According to this configuration, by disposing the USB charger 50 so as to overlap with the outside of the meter device 40 in the vehicle width direction when seen in a side view, and by disposing the connection port 51a below the meter device 40, the USB charger 50 is disposed compactly and easily visible when seen in a side view of the vehicle, and further, the user can easily recognize the presence of the USB charger 50 by touching the lower portion of the meter device 40.

In the motorcycle 101, the USB charger 50 is connected to the harness 64a which is connected to the in-vehicle power supply, and the support stay 175 is provided with the fixing part (the resin grip 64c) configured to fix the harness 64a, the fixing part is also serving as the restricting part. According to this configuration, the harness fixing part that connects the USB charger 50 attached to the support stay 175 and the in-vehicle power supply also serves as a restricting part that restricts the removal of the USB charger 50, thereby improving the anti-theft properties of the main body of the USB charger 50 without increasing the number of parts.

Further, the present invention is not limited to the embodiments, and for example, the configurations of the embodiments may be applied to a saddle riding vehicle other than a two-wheeled vehicle. The term “saddle riding vehicle” is not limited to off-road vehicles, but includes all vehicles in which the driver straddles the vehicle body, including motorcycles (including bicycles with prime movers and scooter-type vehicles), as well as vehicles with three wheels (including vehicles with one wheel in front and two wheels in the rear, as well as vehicles with two wheels in front and one wheel in the rear) or four wheels (such as four-wheeled buggies). In addition, it also includes vehicles whose prime mover is an electric motor.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A saddle riding vehicle comprising:
a display device configured to display vehicle information;
a vehicle body cover that is disposed in front of the display device and that is overlapping with the display device when seen in a front view of the vehicle; and
a power supply device having a connection port that is able to be connected to external equipment,
wherein the power supply device is disposed between a rear end of the display device and a front end of the vehicle body cover in a vehicle forward/rearward direction and is disposed outside than an outer side of the display device in a vehicle width direction,
the display device and the vehicle body cover are fixed to a vehicle body via a same support frame, and
the power supply device is fixed to the support frame.

2. The saddle riding vehicle according to claim 1, wherein a part of the power supply device at least partially overlaps the display device when seen in a side view of the vehicle.

3. The saddle riding vehicle according to claim 1, wherein a connection port of the power supply device is disposed inside than an outer side of the vehicle body cover in the vehicle width direction when seen in a plan view of the vehicle.

4. The saddle riding vehicle according to claim 1, wherein, when seen in a side view of the vehicle, at least a part of the power supply device overlaps with the vehicle body cover, and the connection port does not overlap with the vehicle body cover.

5. The saddle riding vehicle according to claim 1, further comprising a restricting part configured to restrict movement of the power supply device in a direction of removing the power supply device from the support frame.

6. The saddle riding vehicle according to claim 1, wherein an outer side of the display device which is outside in the vehicle width direction is inclined to be located outward in the vehicle width direction as it goes to the rear of the vehicle when seen in a plan view of the vehicle, and
the power supply device located outside of the display device in the vehicle width direction is inclined such that an insertion/removal direction of the external equipment with respect to the connection port is located outward in the vehicle width direction as it goes to the rear of the vehicle when seen in a plan view of the vehicle.

7. The saddle riding vehicle according to claim 5, wherein the restricting part is provided on the vehicle body cover.

8. The saddle riding vehicle according to claim 1, wherein the power supply device is located below an upper end of the display device in a vehicle upward/downward direction when seen in a side view of the vehicle, and at least a part of the power supply device is disposed at a side facing above and rear of the vehicle in a normal direction of a display surface with reference to the display surface of the display device.

9. The saddle riding vehicle according to claim 8, wherein at least a part of the connection port of the power supply device is disposed on upper rear side of the display surface in the normal direction when seen in a side view of the vehicle.

10. The saddle riding vehicle according to claim 1, wherein the power supply device is connected to a harness connected to an in-vehicle power supply, and
the harness is routed along a rear surface of the vehicle body cover in a vehicle width direction and then coupled to another harness in front of the display device.

11. The saddle riding vehicle according to claim 1, wherein the power supply device is located below an upper end of the display device in a vehicle upward/downward direction when seen in a side view of the vehicle, and at least a part of the power supply device is disposed at a side in front of and below the vehicle in a normal direction of the display surface with reference to a display surface of the display device.

12. The saddle riding vehicle according to claim 1, wherein, when seen in a side view of the vehicle, at least a part of the power supply device overlaps with the display device, and the connection port is located below a lower end of the display device in a vehicle upward/downward direction.

13. The saddle riding vehicle according to claim 5, wherein the power supply device is connected to a harness connected to an in-vehicle power supply,
the support frame is attached with a fixing part configured to fix the harness, and
the fixing part serves as the restricting part.
